(19) United States
(12) Patent Application Publication
(10) Pub. No.: US 2010/0129015 A1
(43) Pub. Date: May 27, 2010

(54) METHOD FOR PRODUCING A COMPONENT MADE OF METAL, PARTICULARLY FOR A HEAD BEARING HOUSING OF A SPRING STRUT, AND SUCH A COMPONENT

(76) Inventors: Uwe Nestlen, Offenburg (DE); Horst Siefermann, Achern-Wagshurst (DE)

Correspondence Address: HARNESS, DICKEY & PIERCE, P.L.C., P.O. BOX 828, BLOOMFIELD HILLS, MI, 48303, US

(21) Appl. No.: 12/621,539

(22) Filed: Nov. 19, 2009

Related U.S. Application Data
(63) Continuation of application No. PCT/EP2008/002729, filed on Apr. 5, 2008.

(30) Foreign Application Priority Data
May 23, 2007 (DE) 10 2007 025 768.8

(51) Int. Cl. F16C 17/04; F16B 9/00; B21D 11/20

(52) U.S. Cl. 384/425; 403/244; 72/379.2

(57) ABSTRACT

A method for producing a component made of metal, particularly for a head bearing housing of a spring strut. The component comprises a base part and a flange that extends away therefrom. The flange comprises a substantially tubular portion having a first diameter and a collar-type rim portion that adjoins the tubular portion. The free edge of the tubular portion has a second diameter that is greater than the first diameter of the tubular portion. A raw component is provided comprising a base part and a cylindrically tubular portion having a third diameter that is at least greater than the first diameter. The third diameter of the cylindrically tubular portion is reduced to the first diameter at a distance from an edge of the tubular portion by forming by means of a forming tool that is applied to the outside of the tubular portion and that acts approximately radially toward the longitudinal center axis, in such a way that the collar-type rim portion is constituted.

### CROSS REFERENCE TO RELATED APPLICATIONS

The present application is a continuation of pending International Patent Application PCT/EP2008/002729 filed on Apr. 5, 2008 designating the United States, which was published in German as WO 2008/141697, and claims priority of German Patent Application No. 10 2007 025 768.8 filed on May 23, 2007. The entire contents of these priority applications are incorporated herein by reference.

### BACKGROUND OF THE INVENTION

The invention generally relates to a method for producing a component made of metal. More specifically, the invention relates to a method for producing a head bearing housing of a spring strut. Still more specifically, the invention relates to a method for producing a component made of a metal, which comprises a base part and a flange that extends away from the base part, the flange comprising a substantially tubular portion that has a first diameter and comprising a collar-type rim portion that adjoins the tubular portion a free edge of which has a second diameter that is greater than the first diameter of the tubular portion.

The invention further relates to such a component made of metal, in particular to a head bearing housing of a spring strut.

A component of the aforementioned type is preferably used, in the sense of the present invention, for a head bearing housing of a spring strut in the chassis of a motor vehicle. In this case, the substantially tubular portion of the component serves to receive a damper bearing of a shock absorber, which is connected to the head bearing housing. For this purpose, the flange is additionally provided with a rubber-elastic damper element on the inside. In order that the damper element sits firmly in the flange, the free end of the flange, i.e. the end facing away from the base part, is provided with a collar-type rim portion, the free edge of which has a greater diameter than the smallest diameter of the tubular portion, such that the flange has a waisted shape.

In the case of the hitherto comparable components for a head bearing housing, the flange and the base part, constituted by two parts, had been connected to one another by joining, for example welding. In respect of the production costs, however, it is desirable for the supporting flange to be designed as a single piece with the base part.

Owing to the markedly waisted shape of the flange, however, single-piece production of the component mentioned at the outset proves to be problematic. It has been attempted to draw the flange, by a drawing method, in a plurality of drawings, until the tubular portion having the first diameter is obtained. However, in the subsequent folding-over of the free edge by means of a widening process, in order to form the collar-type rim portion whose free edge has a significantly greater diameter than the first diameter of the tubular portion, the collar-type rim portion has always become torn.

### SUMMARY OF THE INVENTION

The invention is therefore based on the object of providing a method, of the type mentioned at the outset, by which the component mentioned at the outset can be produced as a single piece.

The invention is furthermore based on the object of providing a component produced in such a manner.

According to an aspect of the invention, a method for producing a component made of metal is provided, the component comprising a base part and a flange that extends away from the base part, the flange comprising a substantially tubular portion that has a first diameter and comprising a collar-type rim portion that adjoins the tubular portion and a free edge of which has a second diameter that is greater than the first diameter of the tubular portion, the method comprising the steps of: providing a raw component, the raw component comprising a base part and a cylindrically tubular portion having a third diameter that is at least greater than the first diameter, reducing the third diameter of the cylindrically tubular portion to the first diameter at a distance from an edge of the cylindrically tubular portion by forming by means of a forming tool that is applied to an outside of the cylindrically tubular portion and that acts approximately radially toward a longitudinal center axis of the cylindrically tubular portion, in such a way that the collar-type rim portion is constituted.

According to another aspect of the invention, a component made of metal is provided, comprising a base part and a flange that extends away from the base part, the flange comprising a substantially tubular portion that has a first diameter and comprising a collar-type rim portion that adjoins the tubular portion and a free edge of which has a second diameter that is greater than the first diameter of the tubular portion, the component being produced according to a method comprising the steps of: providing a raw component, the raw component comprising a base part and a cylindrically tubular portion having a third diameter that is at least greater than the first diameter, reducing the third diameter of the cylindrically tubular portion to the first diameter at a distance from an edge of the cylindrically tubular portion by forming by means of a forming tool that is applied to an outside of the cylindrically tubular portion and that acts approximately radially toward a longitudinal center axis of the cylindrically tubular portion, in such a way that the collar-type rim portion is constituted.

The method according to the invention is based on a different approach to the production of the waisted shape of the flange for the purpose of realizing the collar-type rim portion, in which there is first provided a raw component having a cylindrically tubular portion, the diameter of which is yet greater than the first diameter that the tubular portion of the finished flange is to have. Instead of the free edge of the tubular portion being subsequently folded over outward in a widening process, in order to form the collar-type rim portion, provision is additionally made, according to the invention, in that the originally cylindrically tubular portion is formed, by means of a radially inwardly acting forming tool that is applied to the outside of the tubular portion and at a distance from the edge of the tubular portion, in such a way that the third diameter is reduced to the lesser, first diameter.

The invention is based on the knowledge that, in the case of the other procedure, namely, producing the originally cylindrically tubular portion already having the first diameter, for example by drawing, a very great hardening of material occurs in the cylindrically tubular portion, with the consequence that the remaining residual formability that is necessary for folding over the edge outward is insufficient, such that tearing of the collar-type rim portion occurs. If, on the other hand, the originally cylindrically tubular portion is produced to have a diameter that is greater than the diameter of the tubular portion of the flange, for example likewise by a drawing method, the hardening of material in the cylindrically tubular portion is substantially less, and the residual formability is entirely sufficient to shape the collar-type rim portion, by the aforementioned forming process by which the waist of the flange is produced by diameter reduction, without there being a risk of the rim portion becoming torn.

The method according to the invention therefore enables the component mentioned at the outset, particularly for a head bearing housing of a spring strut, to be produced as a single piece, and therefore cost-effectively, and nevertheless without a significant spoilage proportion.

In a preferred refinement of the method, the third diameter of the cylindrically tubular portion is greater than the second diameter.

In the reducing of the third diameter of the cylindrically tubular portion to the first diameter, it can be the case, particularly if the first diameter is substantially smaller than the third diameter, that, in the forming for the purpose of shaping the collar-type rim portion, the second diameter of the free edge of the collar type rim portion that is to be achieved is gone below. By means of the aforementioned measure, going below the second diameter can be prevented, advantageously, through provision of a sufficiently large initial diameter.

In a further preferred refinement of the method, the forming comprises rolling or pressing with radially inwardly directed direction of action.

In the context of tests, rolling or pressing have proved to be particularly suitable forming methods in the context of the method according to the invention and, moreover, these methods are controllable.

In a further preferred refinement, the forming comprises a preliminary forming step, by means of a first forming tool, and at least one further forming operation, by means of at least one second forming tool.

In the case of rolling for the purpose of realizing the waist of the flange, or of the collar-type rim portion on the flange, in this case a first diameter reduction of the cylindrically tubular portion can first be performed by means of a preliminary roller, and the further diameter reduction to the first diameter can then be performed by means of a contour roller. The advantage of a two-stage or multi-stage procedure in the case of the forming operation for the purpose of realizing the collar-type rim portion consists in that the method according to the invention can be adapted flexibly to differing final geometries of the component, in which case, for example, the preliminary forming operation can be the same for the differing geometries.

In a further preferred refinement, an axial pressure is exerted, at least for a time, upon the edge of the tubular portion during forming.

This measure is advantageous particularly if the free edge of the collar-type rim portion is to extend as transversely as possible relative to the longitudinal axis of the flange, because the axial pressure in conjunction with the radially inwardly acting forming force helps to turn the free edge of the collar-type rim portion outward.

In a further preferred refinement, the raw component is prefabricated from a metal blank, from which the cylindrical, tubular portion having the third diameter is drawn.

In this refinement, the method comprises a combination of a drawing method, particularly deep-drawing, with a subsequent forming for the purpose of diameter reduction, particularly rolling or pressing, as mentioned above. In this development, the component according to the invention can therefore be produced very cost-effectively overall. Since the cylindrically tubular portion of the raw component is drawn to have a greater diameter than the first diameter that is to be achieved subsequently, the number of drawings in the case of the drawing operation is advantageously reduced, further reducing the costs of the method according to the invention.

A component, according to the invention, made of metal, particularly for a head bearing housing of a spring strut, comprising a base part and a flange that extends away therefrom, the flange comprising a substantially tubular portion that has a first diameter and comprising a collar-type rim portion that adjoins the tubular portion and the free edge of which has a second diameter that is greater than the first diameter of the tubular portion, is produced according to a method according to one or more of the aforementioned configurations.

Preferably, the base part and the flange are realized to constitute a single piece with one another, this being rendered possible by the method according to the invention.

In a preferred embodiment, the component produced by the method according to the invention is a head bearing housing of a spring strut.

Further advantages and features are disclosed by the following description and the appended drawing.

It is understood that the above-mentioned features and those to be explained in the following can be applied, not only in the respectively specified combination, but also in other combinations or singly, without departure from the scope of the present invention.

### BRIEF DESCRIPTION OF THE DRAWINGS

An exemplary embodiment of the invention is represented in the drawing and described more fully in the following with reference to this drawing, wherein:

FIG. 1 shows, in cross-section along a plane that includes the longitudinal center axis of the component, a component made of metal for a head bearing housing of a spring strut;

FIG. 2 shows, in cross-section, a raw component according to an example not according to the invention;

FIG. 3 shows a raw component in an embodiment according to the invention, for the production of a component made of metal for a head bearing housing of a spring strut, similar to the component in FIG. 1;

FIG. 4 shows a schematic representation of a tool arrangement for forming the raw component in FIG. 3, in a first forming stage;

FIG. 5 shows, in cross-section, the raw component in FIG. 3 after the forming according to FIG. 4;

FIG. 6 shows, partially in a sectional representation, a tool arrangement for the further forming of the raw component in FIG. 5; and

FIG. 7 shows, in cross-section, the raw component obtained after the further forming according to FIG. 6.

### DETAILED DESCRIPTION OF A PREFERRED EXEMPLARY EMBODIMENT

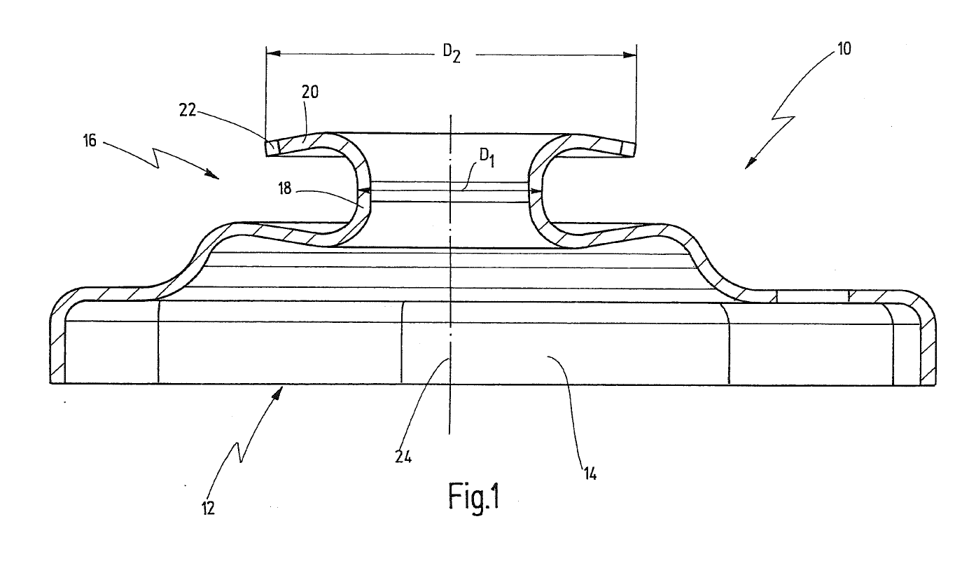

Represented in FIG. 1 and having the general reference 10 is a component made of metal, particularly of steel, which can be used for a head bearing housing of a spring strut.

The component 10 has a base part 12, which is realized in the form of a plate 14. In the context of the present invention, the base part 12 may be of any shape and is adapted, expediently, to the respective spring strut, according to the intended application of the component 10.

Extending away from the base part 12 is a flange 16, which serves as a supporting flange for a damper bearing.

The flange 16 has a substantially tubular portion 18, which has a first diameter D₁, the first diameter D₁ to be understood, in the present description, as the smallest diameter D₁ of the flange 16. It is immaterial in this case whether the diameter D₁ as shown in FIG. 1 is the outer diameter of the tubular portion 18 or the corresponding inner diameter of the tubular portion 18, the latter resulting from the difference of the outer diameter and double the material thickness of the tubular portion 18.

At its free end, i.e. the end facing away from the base part 12, the flange 16 has a collar-type rim portion 20 that adjoins the tubular portion and the free edge of which has a second diameter D₂ that is substantially greater than the first diameter D₁ of the tubular portion 18.

The flange 16 is realized overall to be rotationally symmetrical about a longitudinal axis 24 of the component 10.

Following completion of the component 10, there is inserted in the flange 16, for example, an elastic damper element, not represented, in the form of a rubber element, the damper element being able to be well fixed in place, owing to the waisted shape of the inside of the flange 16.

As evident from FIG. 1, the flange 16 is realized to constitute a single piece or single part with the base part 12.

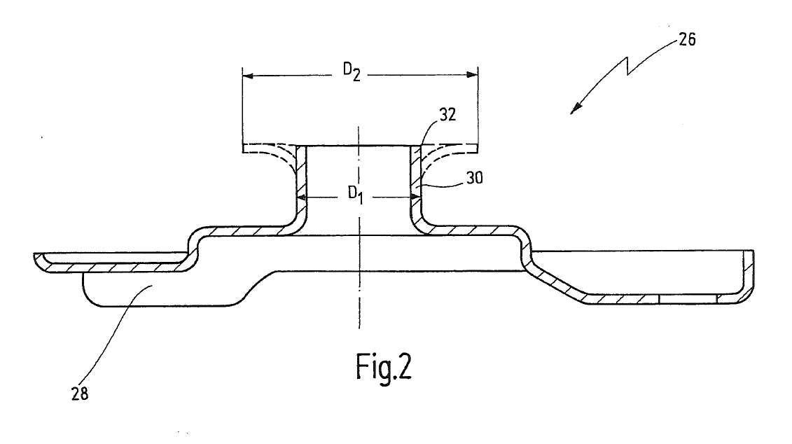

It is described in the following, with reference to the schematic FIGS. 2 to 7, how the component 10 can be produced from a raw component through cold-forming or hot-forming (preferably cold-forming).

The raw components represented in FIGS. 2 to 7 are not true to scale in relation to FIG. 1 and each other, but references to the first diameter D₁ and to the second diameter D₂ are to be understood in the sense of FIG. 1.

FIG. 2 shows a single-piece raw component 26, which is not suitable for producing the component according to FIG. 1.

The raw component 26 has a base part 28 and a cylindrically tubular portion 30. The cylindrically tubular portion 30 has already been drawn, through a plurality of drawings in a deep-drawing process, to the first, small diameter D₁.

Consideration could now be given to producing the collar-type rim portion on the cylindrically tubular portion 30 by folding over a free end 32 of the cylindrically tubular portion 30 outward, i.e. bending the free end 32 outward, as represented by the broken lines in FIG. 2. This procedure in the shaping of the collar-type rim portion 20 in FIG. 1 has the disadvantage, however, that the material in the region of the free edge 32 becomes torn in the case of this forming operation. Tearing of the material is all the more probable since the diameter D₂ is substantially greater than the diameter D₁. The reason for the tearing of the edge 32 is that, in the shaping of the cylindrically tubular portion 30 already having the small, first diameter D₁, many drawings are required in the deep-drawing process, this causing great hardening of material in the cylindrically tubular portion 30, as a result of which the residual formability of the cylindrically tubular portion 30 is no longer sufficient, when the edge 32 is being bent outward, to obtain a collar-type rim portion having a large diameter D₂.

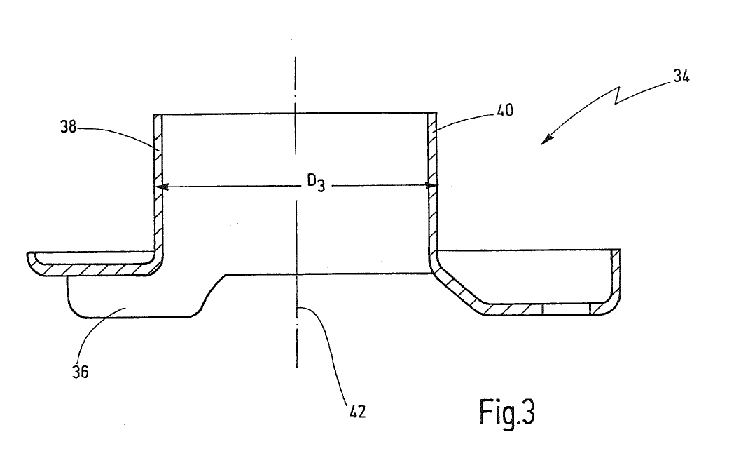

Shown in FIG. 3, by contrast, is a raw component 34 that is used in the method according to the invention for producing a component such as that according to FIG. 1.

The raw component 34 again has a base part 36 and a cylindrically tubular portion 38. The base part 36 differs from the base part 12 of the component 10, but it is understood that the base part 36 may be identical to the base part 12, and that only a schematic drawing is presented here. The cylindrically tubular portion 38 has again been drawn out of the base part 36 in a deep-drawing process, but having, unlike the raw component 26 in FIG. 2, a third diameter D₃ that is greater than the first diameter D₁ of the tubular portion 18 of the finished component 10.

The diameter D₃ in this case can be equal to the second diameter D₂ of the finished collar-type rim portion 20 or, also, yet greater than this second diameter D₂.

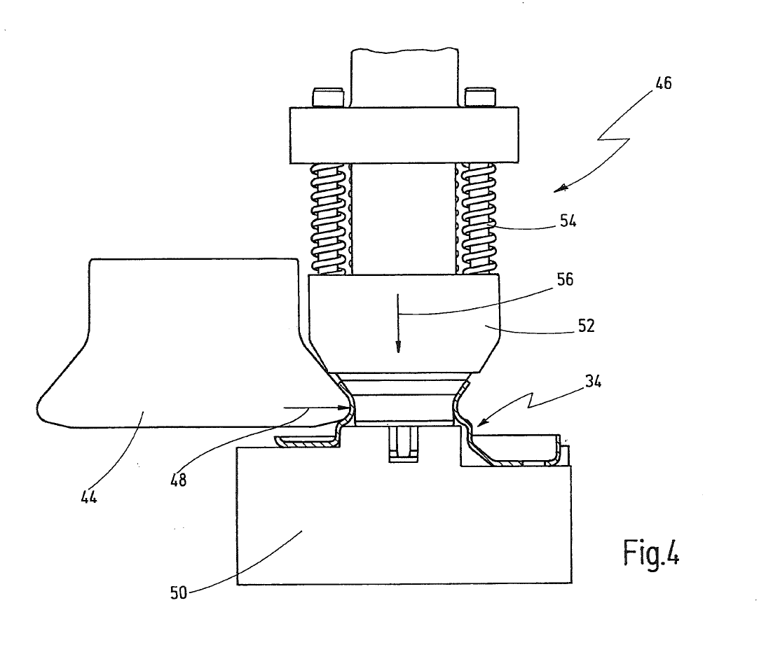

Unlike the procedure according to FIG. 2, in which the collar-type rim portion 20 is shaped by folding over the free end or edge 32 outward, the third diameter D₃ of the cylindrically tubular portion 38 is reduced, starting from the raw component 34 in FIG. 3, by a forming tool 44 that is applied to the outside of the tubular portion 38, at a distance from an edge 40 of the tubular portion 38, and that acts approximately radially toward the longitudinal center axis 42, in order to constitute the collar-type rim portion 20 in FIG. 1. This procedure is represented in FIGS. 4 to 7.

FIG. 4 shows the raw component 34 in a tool arrangement 46, which comprises the forming tool 44. The forming tool 44 is a roller that exerts a radially inwardly directed pressure upon the outside of the cylindrically tubular portion 38 of the raw component 34, as indicated by an arrow 48 in FIG. 4.

The tool arrangement 46 has a tool holder 50 for holding the raw component 34, and has a pressing-on means 52, which, for example by means of the force of springs 54, exerts, at least for a time, an axial pressure, according to an arrow 56, upon the end 40 of the tubular portion 38.

The forming tool 44 is a preliminary roller, by means of which, in a first stage, a preliminary forming operation is performed for the purpose of initially reducing the third diameter D₃ by pressing-in or rolling.

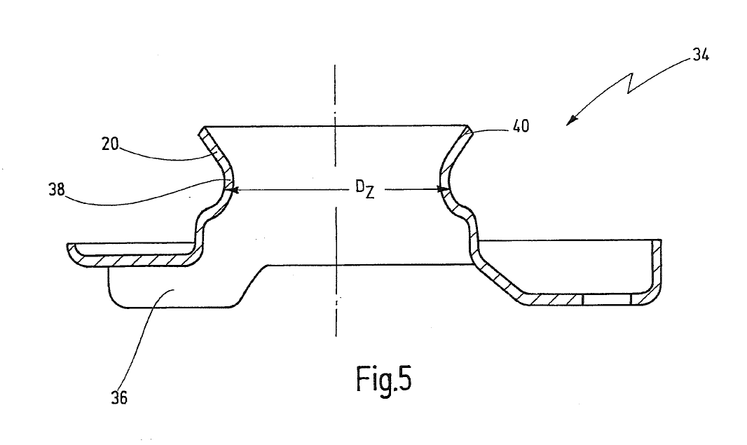

A raw component 34 after the forming operation shown in FIG. 4 is represented in FIG. 5. After the preliminary rolling or preliminary pressing, the tubular portion 38 has been reduced, at a distance from the free edge 40, to an intermediate diameter D₂, the collar-type rim portion 20′ having been constituted in an initial state.

Proceeding from the forming stage according to FIG. 5, the raw component 34 in the tool arrangement 46 is now pressed-in further by radially inwardly directed force, according to an arrow 60, by means of a further forming tool 58, which is likewise realized as a roller, for example as a contour roller, the pressing-on means 52 continuing to exert an axial pressure, at least for a time, upon the free edge 40.

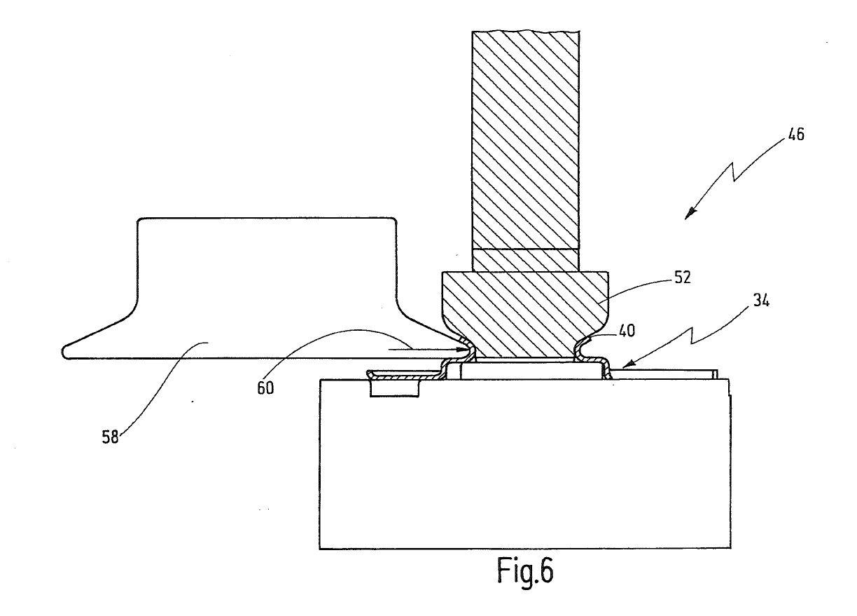

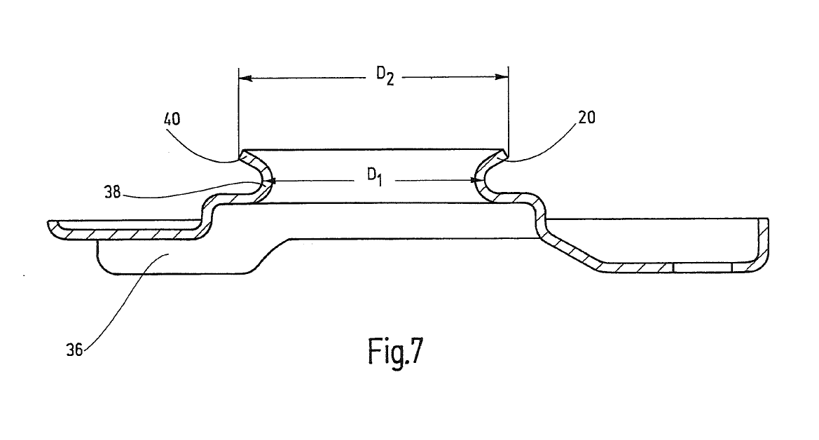

The raw component 34 after the further forming according to FIG. 6 is represented by itself in FIG. 7.

In principle, the further forming according to FIG. 6 can be so performed that the tubular portion 38 has now been reduced to the final first diameter D₁ by the rolling or pressing-in and the collar-type rim portion 20 has already been shaped with the finished second diameter D₂.

In order to achieve the exact design of the component 10 according to FIG. 1, however, further rolling or pressing-in operations can also be performed, depending on the predefined shape of the finished component 10.

In the case of the method according to the invention, which is based on shaping the tubular portion 18 of the finished component 10 having the first diameter D₁ by inwardly directed forming of the tubular portion 38 of the raw component 34, and on thereby constituting the collar-type rim portion 20, it has been found that the collar-type rim portion 20 does not tend to become torn.

What is claimed is:

1. A method for producing a component made of metal, said component comprising a base part and a flange that extends away from said base part, said flange comprising a substantially tubular portion that has a first diameter and comprising a collar-type rim portion that adjoins said tubular portion and a free edge of which has a second diameter that is greater than said first diameter of said tubular portion, the method comprising the steps of:
providing a raw component, said raw component comprising a base part and a cylindrically tubular portion having a third diameter that is at least greater than said first diameter,
reducing said third diameter of said cylindrically tubular portion to said first diameter at a distance from an edge of said cylindrically tubular portion by forming by means of a forming tool that is applied to an outside of said cylindrically tubular portion and that acts approximately radially toward a longitudinal center axis of said cylindrically tubular portion, in such a way that said collar-type rim portion is constituted.

2. The method of claim 1, wherein said third diameter of said cylindrically tubular portion is greater than said second diameter.

3. The method of claim 1, wherein said forming comprises rolling with radially inwardly directed direction of action.

4. The method of claim 1, wherein said forming comprises pressing with radially inwardly directed direction of action.

5. The method of claim 1, wherein said forming comprises a preliminary forming operation, by means of a first forming tool, and at least one further forming operation, by means of at least one second forming tool.

6. The method of claim 1, wherein an axial pressure is exerted, at least for a time, upon said edge of said cylindrically tubular portion during forming.

7. The method of claim 1, wherein said raw component is prefabricated from a metal blank, from which said cylindrically tubular portion having said third diameter is drawn.

8. The method of claim 1, wherein said component to be produced is a head bearing housing of a spring strut.

9. A component made of metal, comprising a base part and a flange that extends away from said base part, said flange comprising a substantially tubular portion that has a first diameter and comprising a collar-type rim portion that adjoins said tubular portion and a free edge of which has a second diameter that is greater than said first diameter of said tubular portion, said component being produced according to a method comprising the steps of:
providing a raw component, said raw component comprising a base part and a cylindrically tubular portion having a third diameter that is at least greater than said first diameter,
reducing said third diameter of said cylindrically tubular portion to said first diameter at a distance from an edge of said cylindrically tubular portion by forming by means of a forming tool that is applied to an outside of said cylindrically tubular portion and that acts approximately radially toward a longitudinal center axis of said cylindrically tubular portion, in such a way that said collar-type rim portion is constituted.

10. The component of claim 9, wherein said base part and said flange are configured monolithically.

11. A head bearing housing of a spring strut, comprising a base part and a flange that extends away from said base part, said flange comprising a substantially tubular portion that has a first diameter and comprising a collar-type rim portion that adjoins said tubular portion and a free edge of which has a second diameter that is greater than said first diameter of said tubular portion, said component being produced according to a method comprising the steps of:
providing a raw component, said raw component comprising a base part and a cylindrically tubular portion having a third diameter that is at least greater than said first diameter,
reducing said third diameter of said cylindrically tubular portion to said first diameter at a distance from an edge of said cylindrically tubular portion by forming by means of a forming tool that is applied to an outside of said cylindrically tubular portion and that acts approximately radially toward a longitudinal center axis of said cylindrically tubular portion, in such a way that said collar-type rim portion is constituted.
